(19) United States
(12) Patent Application Publication
(10) Pub. No.: US 2021/0261426 A1
(43) Pub. Date: Aug. 26, 2021

(54) METHOD FOR PRODUCING HALIDE

(71) Applicant: Panasonic Intellectual Property Management Co., Ltd., Osaka (JP)

(72) Inventors: YUSUKE NISHIO, Osaka (JP); TAKASHI KUBO, Hyogo (JP); AKIHIRO SAKAI, Nara (JP); AKINOBU MIYAZAKI, Osaka (JP)

(21) Appl. No.: 17/317,947

(22) Filed: May 12, 2021

Related U.S. Application Data
(63) Continuation of application No. PCT/JP2019/025439, filed on Jun. 26, 2019.

(30) Foreign Application Priority Data
Dec. 26, 2018 (JP) 2018-243605

(51) Int. Cl. C01D 15/04; C01F 17/265; H01M 10/0525; H01M 10/0562

(52) U.S. Cl. CPC C01D 15/04; C01F 17/265; H01M 2300/008; H01M 10/0562; H01M 10/0525

(57) ABSTRACT

A production method for producing a halide includes a heat-treatment step of heat-treating, in an inert gas atmosphere, a mixed material in which LiBr and YBr₃ are mixed. In the heat-treatment step, the mixed material is heat-treated at higher than or equal to 200° C. and lower than or equal to 650° C.

### BACKGROUND

### 1. Technical Field

The present disclosure relates to a production method for producing a halide.

### 2. Description of the Related Art

International Publication No. 2018/025582 discloses a production method for producing a halide solid electrolyte.

### SUMMARY

In existing technology, it is desired to produce a halide by a method having industrially high productivity.

In one general aspect, the techniques disclosed here feature a production method for producing a halide including heat-treating, in an inert gas atmosphere, a mixed material in which LiBr and YBr₃ are mixed, in which the mixed material is heat-treated at higher than or equal to 200° C. and lower than or equal to 650° C.

According to the present disclosure, a halide can be produced by a method having industrially high productivity.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a flowchart showing an example of a production method in Embodiment 1;

FIG. 2 is a flowchart showing an example of the production method in Embodiment 1;

FIG. 3 is a flowchart showing an example of the production method in Embodiment 1;

FIG. 4 is a schematic diagram showing a method for evaluating ionic conductivity; and

FIG. 5 is a graph showing the results of evaluation of ionic conductivity by AC impedance measurement.

### DETAILED DESCRIPTION

Embodiments will be described below with reference to the drawings.

### Embodiment 1

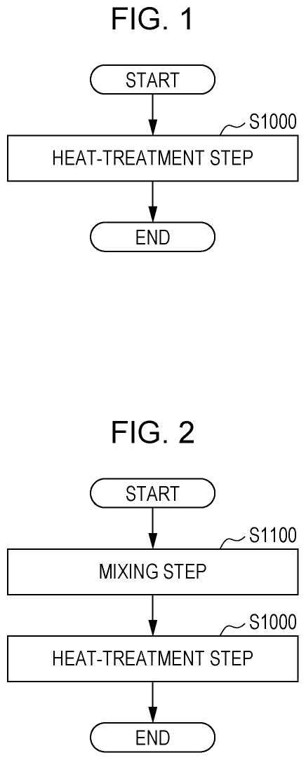

FIG. 1 is a flowchart showing an example of a production method in Embodiment 1. A production method in Embodiment 1 includes a heat-treatment step S1000. The heat-treatment step S1000 is a step of heat-treating a mixed material in an inert gas atmosphere. The mixed material heat-treated in the heat-treatment step S1000 is a material in which LiBr (i.e., lithium bromide) and YBr₃ (i.e., yttrium bromide) are mixed. In the heat-treatment step S1000, the mixed material is heat-treated at higher than or equal to 200° C. and lower than or equal to 650° C.

According to the structure described above, a halide can be produced by a method having industrially high productivity (e.g., a method enabling low-cost mass production). That is, without using a vacuum-sealed tube and a planetary ball mill, a bromide containing Li (i.e., lithium) and Y (i.e., yttrium) can be produced by a simple and easy production method (i.e., heat-treatment in an inert gas atmosphere).

In the heat-treatment step S1000, for example, powder of the mixed material may be placed in a container (e.g., a crucible) and heat-treated in a heating furnace. In this case, the state in which the mixed material is heated to a temperature of “higher than or equal to 200° C. and lower than or equal to 650° C.” in an inert gas atmosphere may be held for more than or equal to a predetermined time. Furthermore, the heat-treatment time may be a time period that does not cause a compositional change of a heat-treated product due to volatilization of a halide or the like (i.e., does not impair the ionic conductivity of the heat-treated product).

Note that as the inert gas, helium, nitrogen, argon, or the like can be used.

Furthermore, after the heat-treatment step S1000, the heat-treated product may be taken out of the container (e.g., a crucible) and pulverized. In this case, the heat-treated product may be pulverized with a pulverizing apparatus (e.g., a mortar, mixer, or the like).

Furthermore, the mixed material in the present disclosure may be a material in which only two materials, i.e., LiBr and YBr₃, are mixed. Alternatively, the mixed material in the present disclosure may be further mixed with another material different from LiBr or YBr₃, in addition to LiBr and YBr₃.

Furthermore, in the present disclosure, the mixed material may be further mixed with M_{α}A_{β}, where M includes at least one element selected from the group consisting of Na, K, Ca, Mg, Sr, Ba, Zn, In, Sn, Bi, La, Ce, Pr, Nd, Pm, Sm, Eu, Gd, Tb, Dy, Ho, Er, Tm, Yb, and Lu; A is at least one element selected from the group consisting of CI, Br, and I; and α>0 and β>0 are satisfied.

According to the structure described above, it is possible to improve the properties (e.g., ionic conductivity and the like) of a halide produced by the production method of the present disclosure.

Note that, when “α=1”, “2≤β≤5” may be satisfied.

Furthermore, in the present disclosure, the mixed material may be further mixed with at least one of LiF or YF₃.

According to the structure described above, it is possible to improve the properties (e.g., ionic conductivity and the like) of a halide produced by the production method of the present disclosure.

Furthermore, in the present disclosure, the mixed material may be mixed with a material in which a part of Li in LiBr (or a part of Y in YBr₃) is replaced with substituting cation species (e.g., M described above). Furthermore, the mixed material may be mixed with a material in which a part of Br in LiBr (or a part of Br in YBr₃) is replaced with F (i.e., fluorine).

FIG. 2 is a flowchart showing an example of the production method in Embodiment 1. As shown in FIG. 2, the production method in Embodiment 1 may further include a mixing step S1100.

The mixing step S1100 is a step carried out before the heat-treatment step S1000. In the mixing step S1100, a mixed material (i.e., a material to be heat-treated in the heat-treatment step S1000) is obtained by mixing LiBr and YBr₃ serving as starting materials.

In the mixing step S1100, LiBr and YBr₃ may be weighed so as to have a desired molar ratio and mixed. As the mixing method for mixing the starting materials, a method in which a commonly known mixing apparatus (e.g., a mortar, blender, ball mill, or the like) is used may be employed. For example, in the mixing step S1100, powders of the starting materials may be prepared and mixed. In this case, in the heat-treatment step S1000, a mixed material in the form of powder may be heat-treated. Furthermore, the mixed material in the form of powder obtained in the mixing step S1100 may be shaped into pellets by uniaxial pressing. In this case, in the heat-treatment step S1000, by heat-treating the mixed material in the form of pellets, a halide may be produced.

Furthermore, in the mixing step S1100, a mixed material may be obtained by mixing, in addition to LiBr and YBr₃, another starting material different from LiBr or YBr₃ (e.g., M_{α}A_{β}, LiF, YF₃, or the like described above).

Note that in the mixing step S1100, a mixed material may be obtained by mixing “a starting material containing LiBr as a main component” and “a starting material containing YBr₃ as a main component”.

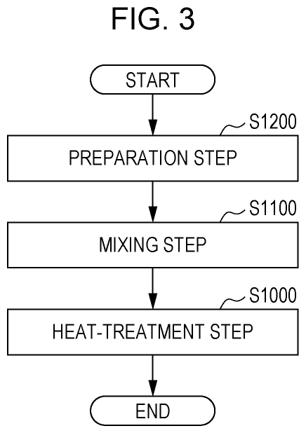

FIG. 3 is a flowchart showing an example of the production method in Embodiment 1. As shown in FIG. 3, the production method in Embodiment 1 may further include a preparation step S1200.

The preparation step S1200 is a step carried out before the mixing step S1100. In the preparation step S1200, starting materials such as LiBr and YBr₃ (i.e., materials to be mixed in the mixing step S1100) are prepared.

In the preparation step S1200, starting materials such as LiBr and YBr₃ may be obtained by synthesizing materials. Alternatively, in the preparation step S1200, commonly known, commercially available products (e.g., materials with a purity of greater than or equal to 99%) may be used. Note that dry materials may be used as the starting materials. Furthermore, starting materials in the form of crystals, aggregates, flakes, powder, or the like may be used as the staring materials. In the preparation step S1200, starting materials in the form of powder may be obtained by pulverizing starting materials in the form of crystals, aggregates, or flakes.

In the preparation step S1200, any one or two or more of M_{α}A_{β} (where M is at least one element selected from the group consisting of Na, K, Ca, Mg, Sr, Ba, Zn, In, Sn, Bi, La, Ce, Pr, Nd, Pm, Sm, Eu, Gd, Tb, Dy, Ho, Er, Tm, Yb, and Lu; A is at least one element selected from the group consisting of CI, Br, and I; and when “α=1”, “2≤β≤5” is satisfied), LiF, and YF₃ may be added. In this way, it is possible to improve the properties (e.g., ionic conductivity and the like) of a halide obtained by the production method of the present disclosure.

Note that in the preparation step S1200, a starting material in which a part of Li in LiBr (or a part of Y in YBr₃) is replaced with substituting cation species (e.g., M described above) may be prepared. Furthermore, in the preparation step S1200, a starting material in which a part of Br in LiBr (or a part of Br in YBr₃) is replaced with F (i.e., fluorine) may be prepared.

Note that the halide produced by the production method of the present disclosure can be used as a solid electrolyte material. In this case, the solid electrolyte material may be, for example, a solid electrolyte having lithium ion conductivity. In this case, the solid electrolyte material can be used, for example, as a solid electrolyte material used in all-solid-state lithium secondary batteries.

### Embodiment 2

Embodiment 2 will be described below. Descriptions that are duplicate of those in Embodiment 1 will be omitted appropriately.

A production method in Embodiment 2 has the following feature in addition to the feature of the production method in Embodiment 1 described above.

In the heat-treatment step S1000 of the production method in Embodiment 2, the mixed material in which LiBr and YBr₃ are mixed is heat-treated at higher than or equal to 300° C. and lower than or equal to 600° C.

According to the structure described above, a bromide having high ionic conductivity can be produced by a method having industrially high productivity. That is, by setting the heat-treatment temperature to be higher than or equal to 300° C., LiBr and YBr₃ are allowed to react with each other sufficiently. Furthermore, by setting the heat-treatment temperature to be lower than or equal to 600° C., it is possible to suppress thermal decomposition of a bromide formed by a solid phase reaction. Thus, the ionic conductivity of a bromide, which is a heat-treated product, can be further enhanced. That is, for example, a high-quality bromide solid electrolyte can be obtained.

Furthermore, in the heat-treatment step S1000 of the production method in Embodiment 2, the mixed material may be heat-treated at higher than or equal to 400° C. (e.g., higher than or equal to 400° C. and lower than or equal to 600° C.).

According to the structure described above, a bromide having higher ionic conductivity can be produced by a method having industrially high productivity. That is, by setting the heat-treatment temperature to be higher than or equal to 400° C., the crystallinity of a bromide, which is a heat-treated product, can be further enhanced. Thus, the ionic conductivity of a bromide, which is a heat-treated product, can be further enhanced. That is, for example, a higher-quality bromide solid electrolyte can be obtained.

Furthermore, in the heat-treatment step S1000 of the production method in Embodiment 2, the mixed material may be heat-treated at higher than or equal to 500° C. (e.g., higher than or equal to 500° C. and lower than or equal to 600° C.).

According to the structure described above, a bromide having higher ionic conductivity can be produced by a method having industrially high productivity. That is, by setting the heat-treatment temperature to be higher than or equal to 500° C., the crystallinity of a bromide, which is a heat-treated product, can be further enhanced. Thus, the ionic conductivity of a bromide, which is a heat-treated product, can be further enhanced. That is, for example, a higher-quality bromide solid electrolyte can be obtained.

Furthermore, in the heat-treatment step S1000 of the production method in Embodiment 2, the mixed material may be heat-treated at lower than or equal to 550° C. (e.g., higher than or equal to 300° C. and lower than or equal to 550° C., higher than or equal to 400° C. and lower than or equal to 550° C., or higher than or equal to 500° C. and lower than or equal to 550° C.).

According to the structure described above, a bromide having higher ionic conductivity can be produced by a method having industrially high productivity. That is, by setting the heat-treatment temperature to be lower than or equal to 550° C., heat-treatment can be performed at a temperature equal to or lower than the melting point of LiBr (i.e., 550° C.), and decomposition of LiBr can be suppressed. Thus, the ionic conductivity of a bromide, which is a heat-treated product, can be further enhanced. That is, for example, a higher-quality bromide solid electrolyte can be obtained.

Furthermore, in the heat-treatment step S1000 of the production method in Embodiment 2, the mixed material may be heat-treated for more than or equal to 1 hour and less than or equal to 60 hours.

According to the structure described above, a bromide having higher ionic conductivity can be produced by a method having industrially high productivity. That is, by setting the heat-treatment time to be more than or equal to 1 hour, LiBr and YBr₃ are allowed to react with each other sufficiently. Furthermore, by setting the heat-treatment time to be less than or equal to 60 hours, volatilization of a bromide, which is a heat-treated product, can be suppressed, and it is possible to obtain a bromide having a desired compositional ratio of constituent elements (i.e., a compositional change can be suppressed). Thus, the ionic conductivity of a bromide, which is a heat-treated product, can be further enhanced. That is, for example, a higher-quality bromide solid electrolyte can be obtained.

Furthermore, in the heat-treatment step S1000 of the production method in Embodiment 2, the mixed material may be heat-treated for less than or equal to 24 hours (e.g., more than or equal to 1 hour and less than or equal to 24 hours).

According to the structure described above, by setting the heat-treatment time to be less than or equal to 24 hours, volatilization of a bromide, which is a heat-treated product, can be further suppressed, and it is possible to obtain a bromide having a desired compositional ratio of constituent elements (i.e., a compositional change can be suppressed). Thus, it is possible to further suppress a decrease in the ionic conductivity of a bromide, which is a heat-treated product, due to a compositional change.

Furthermore, in the heat-treatment step S1000 of the production method in Embodiment 2, the mixed material may be heat-treated for less than or equal to 10 hours (e.g., more than or equal to 1 hour and less than or equal to 10 hours).

According to the structure described above, by setting the heat-treatment time to be less than or equal to 10 hours, volatilization of a bromide, which is a heat-treated product, can be further suppressed, and it is possible to obtain a bromide having a desired compositional ratio of constituent elements (i.e., a compositional change can be suppressed). Thus, it is possible to further suppress a decrease in the ionic conductivity of a bromide, which is a heat-treated product, due to a compositional change.

Furthermore, in the mixing step S1100 of the production method in Embodiment 2, the mixing molar ratio of LiBr to YBr₃ may be adjusted by weighing LiBr and YBr₃ so as to have a desired molar ratio, followed by mixing.

For example, in Embodiment 2, LiBr and YBr₃ may be mixed at a molar ratio of LiBr:YBr₃=“3.75:0.75” to “1.5:1.5”.

Furthermore, in the mixing step S1100 of the production method in Embodiment 2, the mixed material may be obtained by further mixing M_{α}Br_{β} (i.e., a compound represented by M_{α}A_{β} in Embodiment 1 where “A” is Br), in addition to LiBr and YBr₃. In this case, in the preparation step S1200 of the production method in Embodiment 2, the MoBrₚ may be prepared as a starting material.

### EXAMPLES

Details of the present disclosure will be described below using examples and a reference example. These are merely exemplary and do not limit the present disclosure. In the following examples, halides produced by a production method according to the present disclosure are produced as solid electrolyte materials and evaluated.

### Example 1

### (Production of Solid Electrolyte Material)

In an argon atmosphere with a dew point of lower than or equal to −60° C., LiBr and YBr₃ were weighed so as to satisfy a molar ratio of LiBr:YBr₃=3:1. These materials were pulverized and mixed with a mortar made of agate. The resulting mixture was placed in a crucible made of alumina, heated to 600° C. in an argon atmosphere, and held for one hour. After heat-treatment, the material was pulverized with a mortar made of agate to produce a solid electrolyte material of Example 1.

### (Evaluation of Ionic Conductivity)

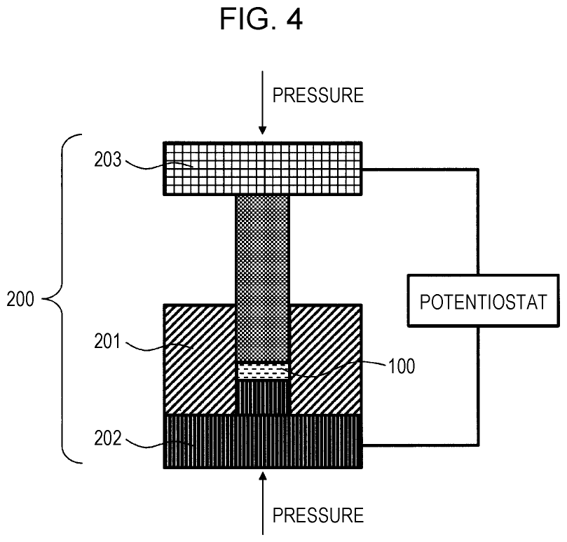

FIG. 4 is a schematic diagram showing a method for evaluating ionic conductivity. A pressure-molding die 200 includes a die 201 which is made of electronically insulating polycarbonate, and an upper punch 203 and a lower punch 202 which are made of electronically conductive stainless steel.

Ionic conductivity was evaluated by the following method using the structure shown in FIG. 4.

In a dry atmosphere with a dew point of lower than or equal to −60° C., the pressure-molding die 200 was filled with solid electrolyte powder 100, which is powder of the solid electrolyte material of Example 1, and uniaxial pressing was performed at 300 MPa to produce a conductivity measurement cell of Example 1. In the pressurized state, lead wires were extended from the upper punch 203 and the lower punch 202 and connected to a potentiostat (Princeton Applied Research, VersaSTAT4) equipped with a frequency response analyzer. The ionic conductivity at room temperature was measured by an electrochemical impedance measurement method.

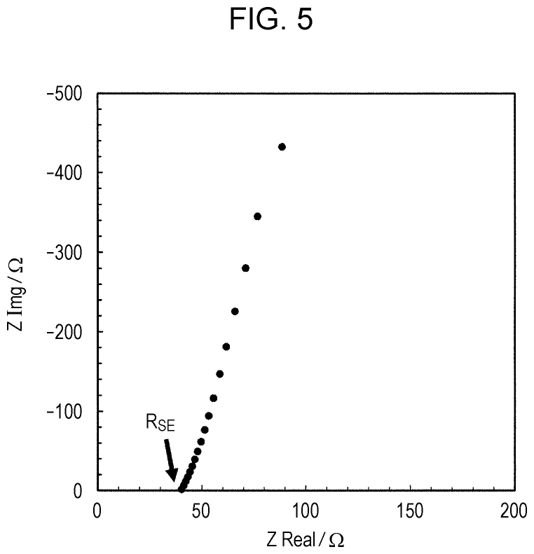

FIG. 5 is a graph showing the results of evaluation of ionic conductivity by AC impedance measurement. FIG. 5 shows a Cole-Cole diagram of the impedance measurement results.

In FIG. 5, the value of the real part of the impedance at the measurement point (indicated by an arrow in FIG. 5) having the smallest absolute value of the phase of the complex impedance was considered as a resistance value for the ionic conduction of the solid electrolyte of Example 1. The ionic conductivity was calculated from the following formula (1) using the resistance value of the electrolyte.

σ=(R_{SE}×S/t)⁻¹ (1)

where σ is the ionic conductivity, S is the area of the electrolyte (in FIG. 4, the inside diameter of the die 201), R_{SE} is the resistance value of the solid electrolyte in the above-mentioned impedance measurement, and t is the thickness of the electrolyte (in FIG. 4, the thickness of the solid electrolyte powder 100).

The ionic conductivity of the solid electrolyte material of Example 1 measured at 25° C. was 1.5×10⁻³ S/cm.

### Examples 2 to 21

### (Production of Solid Electrolyte Material)

In Examples 2 to 19, as in Example 1, in an argon atmosphere with a dew point of lower than or equal to −60° C., LiBr and YBr₃ were weighed so as to satisfy a molar ratio of LiBr:YBr₃=3:1.

In Example 20, in an argon atmosphere with a dew point of lower than or equal to −60° C., LiBr and YBr₃ were weighed so as to satisfy LiBr:YBr₃=3.75:0.75.

In Example 21, in an argon atmosphere with a dew point of lower than or equal to −60° C., LiBr and YBr₃ were weighed so as to satisfy LiBr:YBr₃=1.5:1.5.

These materials were pulverized and mixed with a mortar made of agate. The resulting mixture was placed in a crucible made of alumina, heated to 300 to 600° C. in an argon atmosphere, and held for 1 to 60 hours. In each Example, the “intended composition”, “heat-treatment temperature”, and “heat-treatment time” are shown in Table 1 below.

After heat-treatment under the corresponding heat-treatment conditions, pulverization was performed with a mortar made of agate to produce a solid electrolyte material of each of Examples 2 to 21.

### (Evaluation of Ionic Conductivity)

By the same method as that of Example 1 described above, a conductivity measurement cell of each of Examples 2 to 21 was produced, and measurement of ionic conductivity was performed.

### Reference Example 1

### (Production of Solid Electrolyte Material)

In Reference Example 1, in an argon atmosphere with a dew point of lower than or equal to −60° C., LiBr and YBR₃ were weighed so as to satisfy a molar ratio of LiBr:YBr₃=3:1. These materials were pulverized and mixed with a mortar made of agate. The resulting mixture was placed in a crucible made of alumina, heated to 200° C. in an argon atmosphere, and held for one hour. After heat-treatment, the material was pulverized with a mortar made of agate to produce a solid electrolyte material of Reference Example 1.

### (Evaluation of Ionic Conductivity)

By the same method as that of Example 1 described above, a conductivity measurement cell of Reference Example 1 was produced, and measurement of ionic conductivity was performed.

The compositions and the evaluation results in Examples 1 to 21 and Reference Example 1 are shown in Table 1.

TABLE 1

| | Molar mixing ratio | | | Heat- | | |
|---|---|---|---|---|---|---|
| | of starting | | | treatment | Heat- | |
| | materials | | | temperature | treatment | Conductivity |
| | LiBr | YBr₃ | Composition | (° C.) | time (hr) | (S · cm⁻¹) |
| Example 1 | 3 | 1 | Li₃YBr₆ | 600 | 1 | 1.5 × 10⁻³ |
| Example 2 | 3 | 1 | Li₃YBr₆ | 600 | 15 | 1.3 × 10⁻³ |
| Example 3 | 3 | 1 | Li₃YBr₆ | 550 | 1 | 1.3 × 10⁻³ |
| Example 4 | 3 | 1 | Li₃YBr₆ | 520 | 1 | 1.1 × 10⁻³ |
| Example 5 | 3 | 1 | Li₃YBr₆ | 520 | 5 | 9.3 × 10⁻⁴ |
| Example 6 | 3 | 1 | Li₃YBr₆ | 520 | 10 | 1.2 × 10⁻³ |
| Example 7 | 3 | 1 | Li₃YBr₆ | 520 | 15 | 1.2 × 10⁻³ |
| Example 8 | 3 | 1 | Li₃YBr₆ | 520 | 24 | 1.3 × 10⁻³ |
| Example 9 | 3 | 1 | Li₃YBr₆ | 500 | 1 | 8.4 × 10⁻⁴ |
| Example 10 | 3 | 1 | Li₃YBr₆ | 500 | 10 | 1.5 × 10⁻³ |
| Example 11 | 3 | 1 | Li₃YBr₆ | 500 | 60 | 5.6 × 10⁻⁴ |
| Example 12 | 3 | 1 | Li₃YBr₆ | 450 | 1 | 2.4 × 10⁻⁴ |
| Example 13 | 3 | 1 | Li₃YBr₆ | 450 | 10 | 9.6 × 10⁻⁴ |
| Example 14 | 3 | 1 | Li₃YBr₆ | 400 | 1 | 5.5 × 10⁻⁵ |
| Example 15 | 3 | 1 | Li₃YBr₆ | 400 | 10 | 1.1 × 10⁻⁴ |
| Example 16 | 3 | 1 | Li₃YBr₆ | 400 | 24 | 4.0 × 10⁻⁴ |
| Example 17 | 3 | 1 | Li₃YBr₆ | 400 | 60 | 6.9 × 10⁻⁴ |
| Example 18 | 3 | 1 | Li₃YBr₆ | 350 | 1 | 3.8 × 10⁻⁵ |
| Example 19 | 3 | 1 | Li₃YBr₆ | 300 | 1 | 4.2 × 10⁻⁵ |
| Example 20 | 3.75 | 0.75 | Li_{3.75}Y_{0.75}Br₆ | 500 | 10 | 7.1 × 10⁻⁴ |
| Example 21 | 1.5 | 1.5 | Li_{1.5}Y_{1.5}Br₆ | 500 | 10 | 5.7 × 10⁻⁵ |
| Reference | 3 | 1 | Li₃YBr₆ | 200 | 1 | 4.7 × 10⁻⁶ |
| Example 1 | | | | | | |

### <Considerations>

As in Reference Example 1, in the case where the heat-treatment temperature is 200° C., the ionic conductivity at around room temperature is low at 4.7×10⁻⁶ S/cm. The reason for this is considered to be that in the case where the heat-treatment temperature is 200° C., the solid phase reaction is insufficient. In contrast, in Examples 1 to 21, the ionic conductivity at around room temperature is high at more than or equal to 3.8×10⁻⁵ S/cm.

In the case where the heat-treatment temperature is in the range of 400 to 600° C., a higher ionic conductivity is exhibited. Furthermore, in the case where the heat-treatment temperature is in the range of 500 to 600° C., a much higher ionic conductivity is exhibited. The reason for these is considered to be that a solid electrolyte having high crystallinity has been achieved.

From the above results, it is evident that the solid electrolyte material synthesized by the production method according to the present disclosure has high lithium ion conductivity. Furthermore, the production method according to the present disclosure is a simple and easy method and a method having industrially high productivity.

The production method according to the present disclosure can be used, for example, as a production method for producing a solid electrolyte material. Furthermore, the solid electrolyte material produced by the production method according to the present disclosure can be used, for example, in all-solid-state lithium secondary batteries.

What is claimed is:

1. A production method for producing a halide comprising heat-treating, in an inert gas atmosphere, a mixed material in which LiBr and YBr₃ are mixed,
wherein the mixed material is heat-treated at higher than or equal to 200° C. and lower than or equal to 650° C.

2. The production method according to claim 1, wherein the mixed material is heat-treated at higher than or equal to 300° C. and lower than or equal to 600° C.

3. The production method according to claim 2, wherein the mixed material is heat-treated at higher than or equal to 400° C.

4. The production method according to claim 3, wherein the mixed material is heat-treated at higher than or equal to 500° C.

5. The production method according to claim 2, wherein the mixed material is heat-treated at lower than or equal to 550° C.

6. The production method according to claim 1, wherein the mixed material is heat-treated for more than or equal to 1 hour and less than or equal to 60 hours.

7. The production method according to claim 6, wherein the mixed material is heat-treated for less than or equal to 24 hours.

8. The production method according to claim 7, wherein the mixed material is heat-treated for less than or equal to 10 hours.

9. The production method according to claim 1, wherein the mixed material is further mixed with M_{α}A_{β},
where M includes at least one element selected from the group consisting of Na, K, Ca, Mg, Sr, Ba, Zn, In, Sn, Bi, La, Ce, Pr, Nd, Pm, Sm, Eu, Gd, Tb, Dy, Ho, Er, Tm, Yb, and Lu;
A is at least one element selected from the group consisting of Cl, Br, and I; and
α>0 and β>0 are satisfied.

10. The production method according to claim 1, wherein the mixed material is further mixed with at least one of LiF or YF₃.
